(19) United States
(12) Patent Application Publication
(10) Pub. No.: US 2006/0042480 A1
(43) Pub. Date: Mar. 2, 2006

(54) Canned food screw press

(76) Inventor: Robert Allen Blais, Franklin, MA (US)

Correspondence Address: Robert Blais, 12 Besso Street, Franklin, MA, 02038, US

(21) Appl. No.: 10/926,873

(22) Filed: Aug. 26, 2004

(51) Int. Cl. B30B 1/00

(52) U.S. Cl. 100/230; 100/289

(57) ABSTRACT

A canned food screw press for exerting high compression forces against solid food and liquid mixture packaged in a can forcing the fluid to separate and drain leaving drier solid food. The compact device comprises of a housing having a base for mounting a standard size can with an arch support over it accepting a threaded rod with a handle for turning on one end and a swivel disk on the other that contacts against the top lid of an opened can. The rod moves perpendicular to the can lid when rotated in one direction creating pressing forces against the disk, lid and food. The housing has a handle for stability and draining.

### CROSS REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISK APPENDIX

“Not Applicable”

### BACKGROUND OF THE INVENTION

The present invention relates generally to kitchen appliances and, more particularly, to a canned food screw press designed for ease of use and to provide the user with a mechanical advantage utensil that exerts a leveraged rotational force producing a higher linear force applied to a canned food to forcefully separate liquid from solid canned food products, particularly seafood such as canned tuna fish.

There are many solid food products such as meats, tuna, salmon and the like, and related products that are canned with a high content of liquid, such as water or oil or the like. It is desirable or necessary to remove the liquid from the solid food during food preparation. This is usually achieved by cutting the lid from the can and holding the cut lid against the can contents while the can is inverted to let the liquid drain from the can. This procedure is hazardous because of the sharp edges, messy and ineffective because a limited amount of force can be applied and is based on a persons hand clamping strength. Attempts have been made to address the sharp edges hazard and the messiness issue, but none of the devices can develop the pressure needed to thoroughly remove the liquid from the solid food and liquid mixture in the can.

An object of the present invention is the provision of a simple, inexpensive and compact device in the nature of a rotating mechanical screw press which can be introduced on to the cut can lid or directly to the contents of an opened can of food product canned with liquid, such as fish or sea food with water or oil, and can be tightened with the mechanical leverage of a threaded screw to thoroughly squeeze out fluid from the can while being inverted to allow for draining the fluid.

Another object of the present invention in the provision of a novel screw press implement of the type described in the immediately preceding paragraph, wherein the knob arm length can increase in size to directly increase the amount of torque on the screw which translates to higher axial force transmitted in the screw applied on to the food and liquid mixture, increasing the fluid separation creating drier food.

Other objects, advantages and capabilities of the present invention will become apparent from the following detailed description, taken in conjunction with the accompanying drawings illustrating a preferred embodiment of the invention.

### BRIEF SUMMARY OF THE INVENTION

A canned food press for compressing solid food packaged in a can forcing the fluid to separate and drain leaving drier product. The device comprises of a housing having a base for mounting a standard size can with an arch support over it accepting a threaded rod with a handle for turning on one end and a swivel disk on the other that contacts against the top lid of an opened can. The rod moves perpendicular to the can lid when rotated in one direction creating pressing forces against the disk, lid and food. The housing has a handle for stability and draining.

### BRIEF DESCRIPTION OF THE FIGURES

FIG. 1 is a upright perspective view of a canned screw food press implement constructed in accordance with the present invention;

FIG. 2 is a top elevation view of a canned food screw press on its side;

FIG. 3 is a section view of the can press, taken along the line 3-3 of FIG. 2.

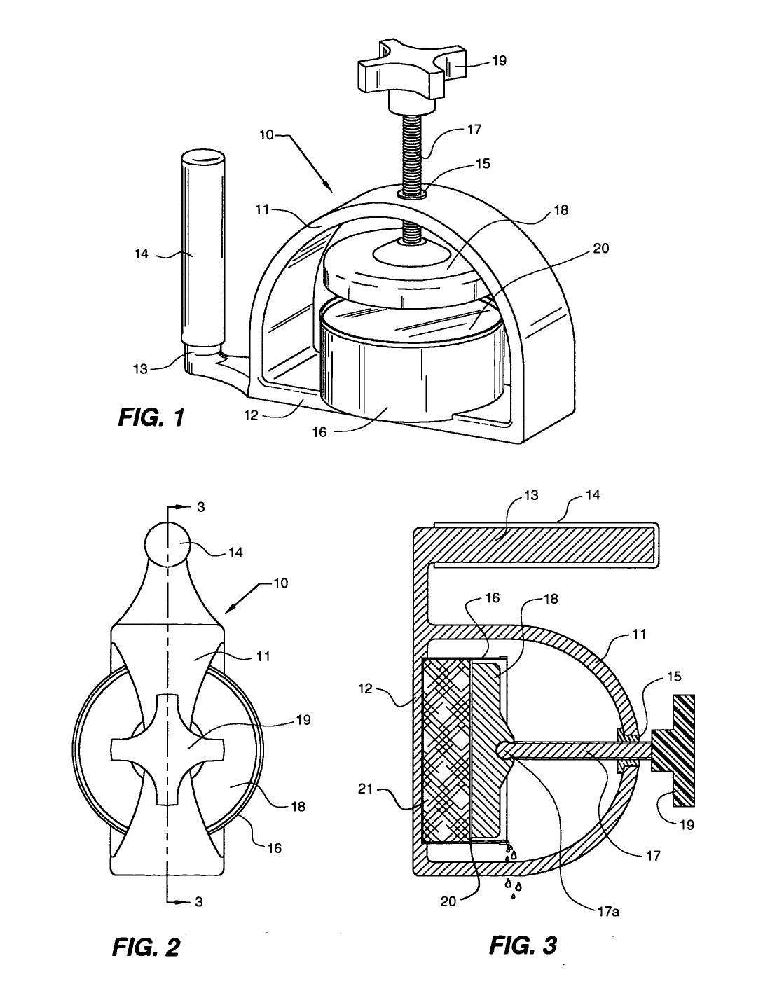

### DETAILED DESCRIPTION OF A PREFERRED EMBODIMENT

Referring now to the drawings in detail there is illustrated a preferred form of the canned food screw press device constructed in accordance with the principles of the present invention and designated generally in its entirety by reference numeral 10 and comprises a housing consisting of an open arch shape 11 with a bottom 12 and a handle 13. The cylindrical handle 13 has a rubberized grip 14 pressed over it and is spaced at distance from the arch to allow for gripping. At the top of the arch 11 is a hole perpendicular to the base 12 accepting a press fit threaded bushing 15. The bushing 15 is cylindrical with a shoulder and an internally threaded hole. The bushing 15 is pressed into the hole in the arch 11 keeping it from rotating. The base 12 of the housing has a circular cut out at a depth and concentric to the top hole in the arch 11 to retain a food can 16. The bottom of the base 12 is flat. A left-handed threaded rod 17 is screwed into the threaded bushing 15. The threaded rod has a molded four-arm knob on one end 19. The arms extend perpendicular to the threaded rod 17 for hand rotation. The opposite end of the threaded rod 17 is rounded 17a and snapped into a similarly contoured hole in disk 18 forming a swivel joint allowing the threaded rod 17 to rotate and the disk 18 to remain stationary. This pivotal coupling of the two members 17, 18 clearly seen in FIG. 3 is constructed to allow for pressure to be placed on the disk 18 from the rotating threaded rod 17 at an angle and without disk 18 rotating.

Rotating knob 19 clockwise rotates the attached threaded rod 17 clockwise. As the threaded rod 17 rotates in the threaded bushing 15, that is fixed in place in the housing arch 12, it moves linearly through the bushing. This translation of rotational force to linear force creates a mechanical advantage to produce more linear force on the disk 18 than is produced by rotational force on the knob 19. The disk 18 attached to the end of the threaded rod 17 is sized to contact the lid 20 of a standard food can found in the market for such food products. The opened lid 20, which has been cut away from the can base or bottom of the can, will be forced against the food 21 by the disk 18 creating compression forces against the food and pressing out the liquid from the food as illustrated in FIG. 3.

The above described canned food screw press will press a majority of the liquid from a canned food product such as tuna fish and the like with a minimum amount of human/input force. The canned food screw press will work with or without the lid present but the lid must be cut away from the can base as shown in FIG. 3. As the food and liquid in the can are being compressed the canned food screw press should be tipped to allow the liquid to flow out. Once the liquid stops flowing the canned food screw press is inverted to the original position and the knob is rotated in the opposite direction, counter clockwise, and the disk is withdrawn from the can.

It is to be understood that the form of this invention herewith shown and described is to be taken as a preferred example of the same, and that this invention is not to be limited to the exact arrangement of parts shown in the accompanying drawings or described in this specification as various changes in the details of construction as to shape, size, and arrangement of parts may be resorted to without departing from the spirit of the invention, the scope of the novel concepts thereof, or the scope of the sub-joined claims.

I claim:

1. A canned food screw press for compressing the solid food and liquid mixture packaged in a can forcing the liquid to separate and drain leaving drier product, comprising housing defining a handle, a base to insert a standard size can, a support housing projecting out over the can, a hole through the housing centered above a can perpendicular to the base; a threaded rod through a threaded bushing pressed into the hole in the top of the support housing with a knob on one end for turning, a disk coupled on the other end of the threaded rod sized to fit into an opened food product can onto the lid; rotating the rod in one direction moves it perpendicular to the can lid exerting high pressing forces against the food solid and liquid mixture in the can to express the fluid therefrom.

2. A canned food screw press as defined in claim 1, wherein the mechanism for creating force against the food/fluid product is created by mechanical advantage of a threaded rod and a rotating knob with a lever arm enabling a person to leverage his strength to exert a large amount of force on the food and liquid mixture in the can with a small amount of effort.

3. A canned food screw press as defined in claim 2, wherein said the mechanical advantage of the threaded rod can be increased by installing a gear reduction train between the knob and the threaded rod.

4. A canned food screw press as defined in claim 2, wherein an electric motor with a reduction gear head drive can be mounted onto the threaded rod for electromechanical operation.

5. A canned food screw press as defined in claim 1, wherein said the threaded rod is a bar with machined, cut, molded angular twisted ribs around the circumference in a helical pattern that engages in a threaded hole for the purpose of producing linear displacement from rotational movement.

6. A canned food screw press as defined in claim 1, wherein said the threaded rod is a screw with standard or ACME style threads.

7. A canned food screw press as defined in claim 1, wherein the threaded rod can be a ball screw thread for strength, stability and to reduced friction in rotation making it easier to rotate.

8. A canned food screw press as defined in claim 1, wherein said knob has one or more arms of the same or different lengths for rotating and creating leverage.

9. A canned food screw press as defined in claim 1, wherein said the disk is shaped to accept a threaded rod end creating a swivel joint to allow for rod rotation without disk rotation.

10. A canned food screw press as defined in claim 1, wherein the disk is slightly convex dished shaped on the plane contacting the can lid to allow for better fluid separation.

11. A canned food screw press as defined in claim 1, wherein the housing has a base and handle for stabilizing, lifting and rotating the device for tightening and draining.

12. A canned food screw press as defined in claim 1, wherein the housing base is constructed to capture the can in place centering it under the threaded rod and disk assembly.

13. A canned food screw press as defined in claim 1, wherein the housing is shaped as an arch or portion of an arch or flat bar to support the force applied from the screw.

14. A canned food screw press as defined in claim 13, wherein the housing support can pivot or hinge away from the can to aide in increasing the accessibility and the speed to engage and disengage the threaded rod and disk assembly.

15. A canned food screw press as defined in claim 1, wherein the threaded bushing can pivot away from the can to aide in increasing the accessibility and the speed to engage and disengage the threaded rod and disk assembly.

16. A canned food screw press as defined in claim 1, wherein the threaded bushing can be a spring-loaded lever mounted to the housing with mating threads that engage and disengage the threaded rod allowing for faster threaded rod and disk assembly insertion and removal.

17. A canned food screw press as defined in claim 1, wherein said threaded bushing can be of a quick acting type for quick installation or removal of the threaded rod as described as a threaded bushing with an elongated hole which accommodates tilting of the threaded rod for disengaging it from the mating threads of the bushing allowing the threaded rod to slide in and out for quicker movement. To engage the threads the threaded rod is moved back into a straightened upright position.
